(19) United States
(12) Patent Application Publication
(10) Pub. No.: US 2019/0282923 A1
(43) Pub. Date: Sep. 19, 2019

(54) DISCRETE EXTRACT COLLECTION SYSTEM FOR CO2-BASED FLUID EXTRACTION

(71) Applicant: Waters Technologies Corporation, Milford, MA (US)

(72) Inventors: Edward J. Ognibene, Belmont, MA (US); Michael Webster, Gibsonia, PA (US); Andrew Sulik, Pittsburgh, PA (US); Steven Stricko, Trafford, PA (US); Andrew Aubin, Taunton, MA (US); Christopher J. Hudalla, Milford, MA (US)

(73) Assignee: Waters Technologies Corporation, Milford, MA (US)

(21) Appl. No.: 16/353,194

(22) Filed: Mar. 14, 2019

Related U.S. Application Data
(60) Provisional application No. 62/643,668, filed on Mar. 15, 2018.

(51) Int. Cl. B01D 11/02; B01D 21/26; B01D 50/00

(52) U.S. Cl. CPC B01D 11/0203; B01D 11/028; B01D 11/0207; B01D 2247/101; B01D 50/004; B01D 11/0292; B01D 21/267

(57) ABSTRACT

The present disclosure relates to methodologies, systems, and devices for discretely collecting extracts from an extract collection container of a CO₂-based extraction system. A removable liner can be placed within the extract collection container such that the extract is collected within the removable liner, which can be removed or collected at discrete times. The removable liner can be hung from an extract fluid inlet tube or attached to an internal sidewall of the extract collection container.

### RELATED APPLICATION

This application claims priority from and the benefit of U.S. Provisional Patent Application No. 62/643,668 filed on Mar. 15, 2018 and titled DISCRETE EXTRACT COLLECTION SYSTEM FOR CO₂-BASED FLUID EXTRACTION, the entire contents of which are incorporated herein by reference.

### FIELD OF THE TECHNOLOGY

The present disclosure generally relates to carbon dioxide (CO₂) based extraction systems. In particular, the present disclosure relates to a discrete extract collection system for use in a CO₂ based extraction system.

### BACKGROUND

CO₂ based extraction systems, such as for example, supercritical fluid extraction (SFE) systems utilizing CO₂ in the extraction fluid, extract chemical compounds using supercritical or near supercritical CO₂ instead of an organic solvent. The supercritical fluid state occurs when a fluid is above its critical temperature and critical pressure, when it is between the typical gas and liquid state. Manipulating the temperature and pressure of the fluid can solubilize the material of interest and selectively extract it. Typically in SFE systems, extracts are collected in a liquid form using a cyclone separator which is periodically tapped by an operator during the extraction process via a valve at the bottom of the cyclone, allowing the fluid to flow freely from the valve. When the collected material is too viscous, or in a solid form, it does not flow freely from a valve and can stick to the sides of the container and contaminate future collections.

### SUMMARY

Collecting extracts from CO₂-based extraction systems raises a number of challenges, especially when dealing with a viscous or solid extracts. Technology for collecting viscous or solid extracts in an efficient and clean manner would be beneficial and highly desirable.

In general, certain embodiments of the present technology feature a device configured to enable discrete collection of extracts from a CO₂-based extract collection container. In certain embodiments, this device is a removable liner that is sized to fit within the extract collection container and cover all or a portion of the interior surface of the collection container. In some embodiments, the removable liner is secured to the interior surface of the collection container using a pressure-fit ring, magnetic force, a clamping mechanism, or using a fluid inlet tube of the extract collection container. During operation of the CO₂-based extraction system, an extract can be collected within the removable liner so that once the fractionation process is complete; the extract can be collected from the container by simply taking the removable liner out from the collection container. In this way, a higher percentage of extract can be collected because little or no extract remains behind on the interior walls of the collection container. This increases yield, and also prevents contamination between different fractionation processes using the same collection container.

In one aspect, the present technology relates to a method of extracting solid materials from liquid, gas or liquid-gas solutions. The method includes securing a first removable liner within an extract collection container of a CO₂-based extraction system having a fluid stream inlet and a fluid stream outlet and closing a cap of the extract collection container. The method also includes collecting a first solid material in the first removable liner by passing a first solution through the fluid stream inlet of the extract collection container. The method also includes depressurizing the extract collection container and removing the removable liner from the extract collection container, and replacing and securing a second removable liner within the extract collection container. In a non-limiting example, the method can also include collecting a second solid material in the second removable liner by passing a second solution through the fluid stream inlet of the extract collection container. In some embodiments, carryover of the first solid material into the second solid material may be less than 10%, or at least 10% less compared to carryover of the first solid material into the second solid material from a hydrocyclone separator without removable liners. In another non-limiting example, passing the first solution through the fluid stream inlet generates an internal spiraling fluid flow to cause at least a partial material separation process. In another non-limiting example, securing the first removable liner within the extract collection container includes securing the removable liner to a cylindrical section detachably connected to an open end of the extract collection container. In another non-limiting example, securing the removable liner to the cylindrical section includes securing the removable liner to inlet tubing that circumferentially lines an internal surface of the cylindrical section. In another non-limiting example, securing the first removable liner within the extract collection container includes positioning an inserted ring on a portion of an open end of the removable liner or using magnetic force to secure the open end of the removable liner to a portion of the extract collection container.

In another aspect, the present technology relates to a CO₂-based extraction system. The system includes an extraction vessel configured to generate an extract fluid flow including a mixture of an extract and CO₂. The system also includes an extract collection container having a fluid stream inlet and a fluid stream outlet, wherein the fluid stream inlet is configured to direct the extract fluid flow into the extract collection container and generate an internal spiraling fluid flow to cause at least a partial material separation process of the extract from the CO₂. The system also includes a removable liner disposed within the extract collection container and covering at least a portion of an inner surface of the extract collection container, wherein the removable liner is configured to collect the extract and is sized to fit within the extract collection container. In a non-limiting example, the fluid stream inlet is a tangential inlet. In another non-limiting example, the removable liner symmetrically covers the between 10% and 100% of the inner surface of the extract collection container. In another non-limiting example, the system also includes a cylindrical section detachably connected to an open end of the extract collection container, and wherein the removable liner is connected to the cylindrical section. In another non-limiting example, the fluid stream inlet includes inlet tubing that circumferentially lines an internal surface of the cylindrical section, and the removable liner is connected to the inlet tubing. In another non-limiting example, the system also includes an inserted ring configured to cover a portion of an open end of the removable liner. In another non-limiting example, the extract collection container is a cone-shaped vessel.

In another aspect, the present technology relates to a hydrocyclone separator. The hydrocyclone separator includes a truncated cone-shaped vessel including a fluid stream inlet and a fluid stream outlet configured to generate an internal spiraling fluid flow in operation to cause at least a partial material separation process, and a truncated end. The hydrocyclone separator also includes a cone-shaped collector including an open end detachably connected to the truncated end of the truncated cone-shaped vessel. The hydrocyclone separator also includes a removable liner disposed within the cone-shaped collector and covering at least a portion of an inner surface of the cone-shaped collector, wherein the liner is configured to collect solid material. In a non-limiting example, the fluid stream inlet is a tangential inlet. In another non-limiting example, the cone-shaped collector defines between 10% and 50% of a conical inner surface of the hydrocyclone separator. In another non-limiting example, the truncated cone-shaped vessel includes a first flange at or near the truncated end, the cone-shaped collector includes a second flange at or near the open end, and a portion of the removable liner is secured between the first flange and the second flange. In another non-limiting example, a conical angle of the truncated cone-shaped vessel and a conical angle of the cone-shaped collector are substantially the same.

The above aspects of the technology provide numerous advantages. For example, systems and methods of the present technology allows for convenient and efficient collection of extracts from an extract collection container without leaving substantial residue behind. In particular, various extracts can be collected in removable liners such that a first extract does not substantially contaminate a second extract that is collected within the same extract collection container, but using a new removable liner. Further, by collecting in a removable liner, 100% or nearly all of the extract can be collected and transferred, thereby increasing yield by reducing loss.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a flow chart of an example method for collecting an extract from a CO₂-based extraction system, according to an embodiment of the present disclosure.

FIG. 2 is a cross sectional view of an example discrete CO₂-based extraction system, according to an embodiment of the present disclosure.

FIG. 3 is a cross sectional view of another example discrete CO₂-based extraction system, according to an embodiment of the present disclosure.

FIG. 4 is a cross sectional view of another example discrete CO₂-based extraction system, according to an embodiment of the present disclosure.

FIG. 5 is a top-down view of an example discrete CO₂-based extraction liner loaded into a cyclone, according to an embodiment of the present disclosure.

FIG. 6 is a diagram of an example CO₂-based extraction system suitable for use with the removable liners described herein, according to an embodiment of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of, methodologies, devices, and systems for CO₂-based extraction. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

During CO₂-based extraction, an extract is separated from CO₂ (i.e., an extraction fluid) within an extract collection container, and the separated extract can be removed from the collection container. In some embodiments, a series of pressurized vessels can be used to separate the different components that are being extracted from a matrix. It may be difficult to collect a viscous or solid extract from the extract collection container, in some embodiments, because the extract can remain on the interior surface of the extract collection container. That is, particles or a residue of the extracted sample may remain on the container. As a result, a subsequent extraction or a second or different sample can be contaminated. According to embodiments of the present disclosure, a removable liner can be placed within the extract collection container such that the extract is collected within the removable liner, which can be removed or collected at discrete times. In a non-limiting example, nearly 100% of the extract can be collected with minimal residue left behind in the extract collection container. In some embodiments, the removable liner can be hung from an extract fluid inlet tube or attached to an internal sidewall of the extract collection container.

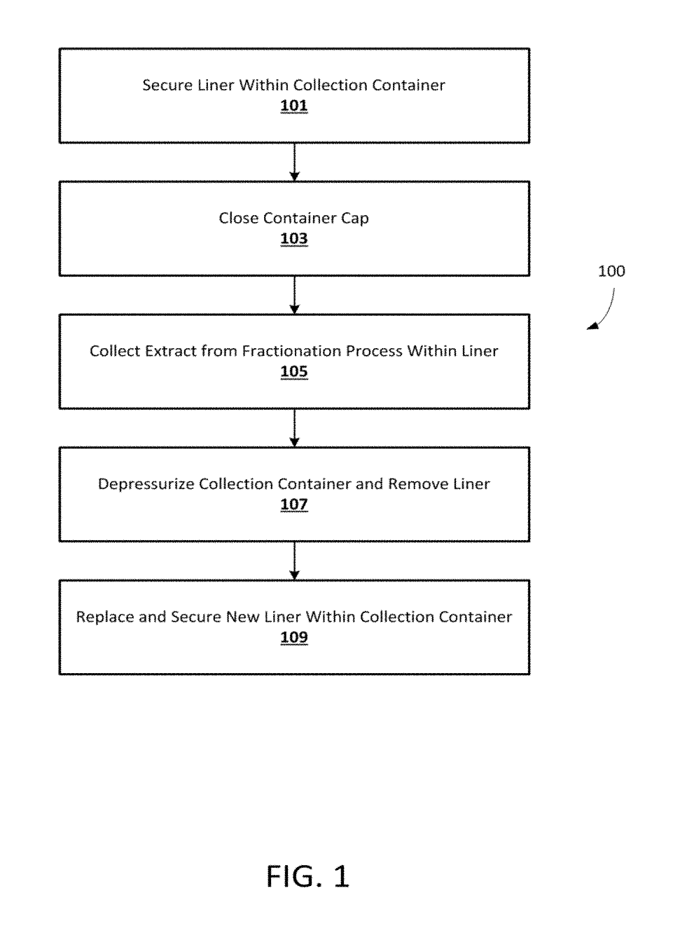

FIG. 1 is a flow chart of an example method for collecting an extract from a CO₂-based extraction system using a discrete removable liner, according to an embodiment of the present disclosure. In step 101, a removable liner is secured within an extract collection container. In a non-limiting example, the removable liner can be secured to the interior surface of the extract collection container using a pressure fit ring or a clamp device. In other embodiments, magnetic force can be used to secure the removable liner to the extract collection container. The removable liner can be attached to or hung from an extract fluid inlet tube, in some embodiments. In other embodiments, the removable liner can have a cutout feature, notch, or opening so that the liner avoids contact with the extract fluid inlet tube. The liner can be secured to the interior of the extract collection container using bottom loading or top loading techniques, in some embodiments. In a non-limiting example, a portion of the open end of the removable liner can be secured to a detachable cylindrical section of the extract collection container. In one such example, inlet tubing can circumferentially line an internal surface of the cylindrical section, and a portion of the open end of the removable liner can be secured to this inlet tubing. In one example of a top loading technique, the removable liner can be positioned within the extract collection container through a top opening in the container and near a fluid inlet tube. In an example of a bottom loading technique, the extract collection container can include two detachable sections or portions, and the removable liner can be secured to the lower detachable portion of the extract collection container before the portions are secured together.

In step 103, an extract collection container cap is closed, and in step 105 an extract is collected within the removable liner from a fractionation process. The solid or viscous extract material can be collected within the removable liner by passing a fluid mixture of CO₂ and the extract through a fluid stream inlet in the extract collection container. In a non-limiting example, passing the mixture through the fluid stream inlet generates an internal spiraling fluid flow within the extract collection container and causes at least a partial material separation process.

In step 107, the extract collection container is depressurized and the removable liner is removed. As discussed above, nearly 100% of the desired extract can be collected within the removable liner, in some embodiments. In a non-limiting example, once the removable liner has been removed from the extract collection container, the extract within the liner can be frozen in order to more easily remove the extract from the liner. For example, freezing the extract can reduce its viscosity and make it easier to remove from the liner. Once removed from the liner, the extract can be placed in another container for post processing, in some embodiments.

In step 109, a new removable liner is secured within the extract collection container in order to perform another round of extraction. As discussed above, the new removable liner can be secured to the extract collection container using, for example, a pressure fit ring or clamp and using bottom loading or top loading techniques. In some embodiments, the a second solid or viscous extract material can be collected in the new removable liner by passing a second fluid solution of CO₂ and the second extract through the fluid stream inlet of the extract collection container, as discussed above. In a non-limiting example, the carryover of the first extract material into the second extract material is less than 10%, and the carryover of the first solid material into the second solid material is at least 10% less compared to a system without removable liners. The use of a removable liner that separates solid and viscous extracts from the collection container and prevents extracts from attaching to the internal surfaces of the collection container can provide this increased purity of extract and reduced carryover or contamination between fractionation runs.

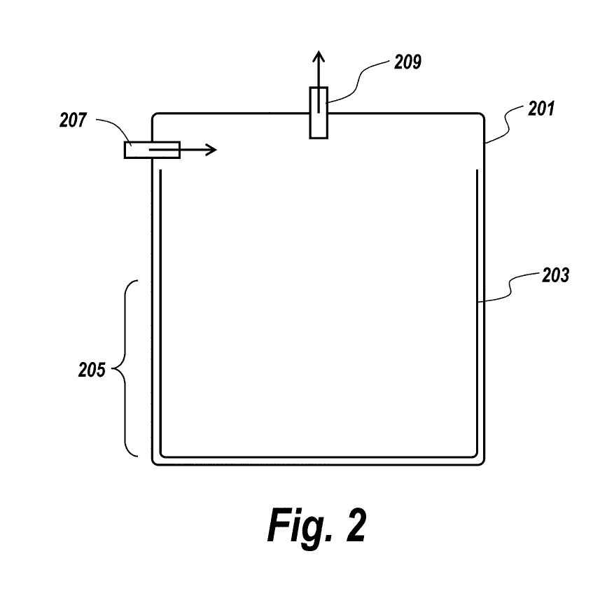

FIG. 2 is a cross sectional view of an example discrete CO₂-based extraction system, according to an embodiment of the present disclosure. In this example embodiment, a removable liner 203 can be placed within an extract collection container 201. The extract collection container 201 can include a fluid stream inlet 207 and a fluid stream outlet 209. In a non-limiting example, the fluid stream outlet 209 is positioned at an upper portion of the extract collection container 201, and the fluid stream inlet 207 and fluid stream outlet 209 are configured to generate an internal spiraling fluid flow when the CO₂-based extraction system is in operation. In some embodiments, the internal spiraling fluid flow causes at least a partial material separation process within the extract collection container 201. The removable liner 203 can be configured, in some embodiments, to symmetrically cover a portion of the inner surface of the extract collection container 201 and collect a solid or viscous extract within a collection portion 205 of the removable liner 203. In a non-limiting example, the removable liner 203 is configured to cover between about 10% and 100% of the inner surface of the extract collection container 201. In another non-limiting example, the extract collection container 201 has a cylindrical design, and the fluid stream inlet 207 is tangential to the extract collection container 201. Such an arrangement can help generate an spiraling fluid flow within the extract collection container 201. In the example shown in FIG. 2, the extract collection container 201 is cylindrical in shape; however, other embodiments may have different geometries. In one embodiment, a detachable cylindrical section can be connected to an openable end of the extract collection container 201, and the removable liner can be connected to this cylindrical section. In such an example embodiment, a top portion of the extract collection container 201 can be releasable or detachable and can function as a cap or lid.

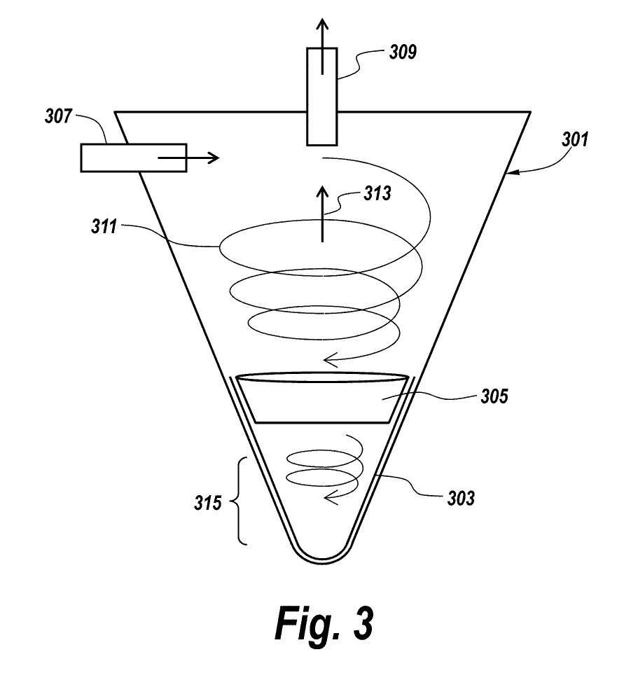

FIG. 3 is a cross sectional view of another example discrete CO₂-based extraction system, according to an embodiment of the present disclosure. In this example embodiment, a removable liner 303 can be placed within an extract collection container 301. The extract collection container 301 can include a fluid stream inlet 307 and a fluid stream outlet 309. In a non-limiting example, the fluid stream outlet 309 is positioned at an upper portion of the extract collection container 301, and the fluid stream inlet 307 and fluid stream outlet 309 are configured to generate a spiraling fluid flow 311 when the CO₂-based extraction system is in operation. In some embodiments, the extract collection container 301 functions as a cyclone separator that uses rotational energy and centrifugal force to help separate materials, such as a solid or viscous extract. In some embodiments, the spiraling fluid flow 311 causes at least a partial material separation process within the extract collection container 301. The removable liner 303 can be configured, in some embodiments, to symmetrically cover a portion of the inner surface of the extract collection container 301 and collect a solid or viscous extract within a collection portion 315 of the removable liner 303. In a non-limiting example, as the extract fluid enters the extract collection container 301 through the fluid stream inlet 307, the extract is entrained with the extract fluid. Once the material separation process occurs, as the spiraling fluid flow reaches a lower collection portion 315 of the removable liner 303, the extract begins to separate from CO₂ within the extract fluid, and the extract is collected within the removable liner 303. In some embodiments, little or no extract attaches to the internal surface of the extract collection container 301 that is not covered by the removable liner 303 because the extract is still entrained within the fluid flow. In a non-limiting example, 90% or more of the vessel interior would be covered by the liner. Once the extract has been separated, remaining gas, such as CO₂, can exit the collection container 301 as a core flow 313 through the fluid stream outlet 309. In a non-limiting example, the removable liner 303 is configured to cover only a portion of the inner surface of the extract collection container 301. In another non-limiting example, the fluid stream inlet 307 is tangential to an internal or external surface of the extract collection container 301 to help generate the spiraling fluid flow 311 within the extract collection container 301. In the example shown in FIG. 3, the extract collection container 301 is a cone-shaped vessel, and the removable liner 303 is secured to the interior surface of the extract collection container 301 using an inserted ring 305 that covers at least a portion of the open end of the removable liner 303. The ring 305 can be pressure fit, in some embodiments, such that it compresses a portion of the removable liner 303 against the interior of the extract collection container 301. The removable liner 303 can be configured, in some embodiments, to symmetrically cover a portion of the inner surface of the extract collection container 301 and collect a solid or viscous extract within a collection portion 315 of the removable liner 303. Once the extract has been separated, remaining gas, such as CO₂, can exit the collection container 301 as a core flow 313 through the fluid stream outlet 309.

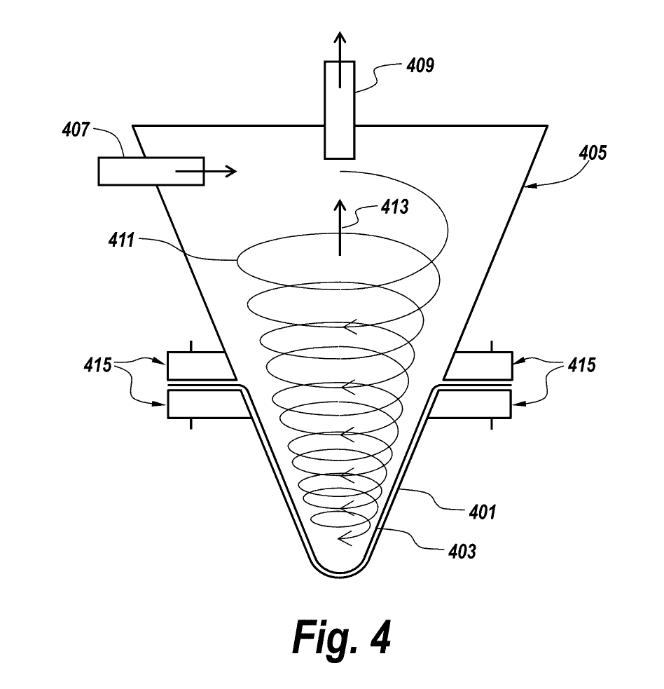

FIG. 4 is a cross sectional view of another example discrete CO₂-based extraction system, according to an embodiment of the present disclosure. In this example embodiment, a removable liner 403 can be placed within an extract collection container 401. In this example embodiment, the extract collection container 401 can be connected to a detachable truncated cone-shaped vessel 405. This truncated cone-shaped vessel 405 can include a fluid stream inlet 407 and a fluid stream outlet 407. In a non-limiting example, the fluid stream outlet 409 is positioned at an upper portion of the truncated cone-shaped vessel 405, and the fluid stream inlet 407 and fluid stream outlet 409 are configured to generate a spiraling fluid flow 411 when the CO₂-based extraction system is in operation. In some embodiments, the extract collection container 401 functions as a cyclone separator that uses rotational energy and centrifugal force to help separate materials, such as a solid or viscous extract. In some embodiments, the spiraling fluid flow 411 causes at least a partial material separation process within the extract collection container 401. The removable liner 403 can be configured, in some embodiments, to symmetrically cover all or a portion of the inner surface of the extract collection container 401 and collect a solid or viscous extract within the removable liner 403. Once the extract has been separated, remaining gas, such as CO₂, can exit the collection container 401 as a core flow 413 through the fluid stream outlet 409. In a non-limiting example, the fluid stream inlet 407 is tangential to an internal or external surface of the truncated conical portion 405 to help generate the spiraling fluid flow 411 within the extract collection container 401. In the example shown in FIG. 4, the extract collection container 401 is a cone-shaped vessel, and the open end of the extract collection container 401 is configured to detachably connect with the truncated end of the truncated cone-shaped vessel 405. In some embodiments, the extract collection container 401 and the truncated cone-shaped vessel 405 are connected using a set of flanges 415 on the open ends of each portion. In a non-limiting example, the removable liner 403 can be secured between the flanges 415 of the extract collection container 401 and the truncated cone-shaped vessel 405. In one example embodiment, the cone-shaped extract collection container 401 defines between 10% and 50% of the total conical inner surface of the hydrocyclone separator. In another example embodiment, the conical angle of the truncated cone-shaped vessel 405 and the conical angle of the cone-shaped extract collection container 401 are substantially the same.

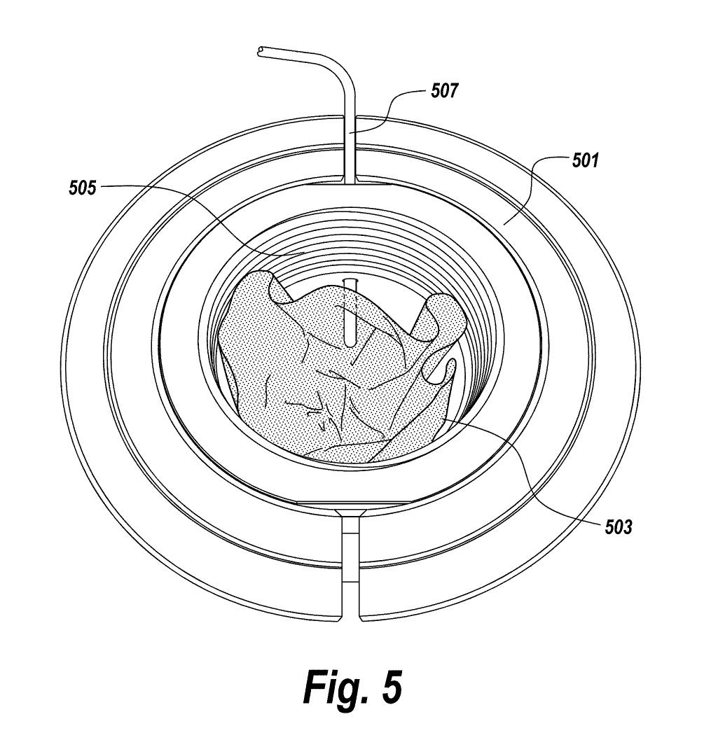

FIG. 5 is a top-down view of an example discrete CO₂-based extraction liner loaded into a cyclone, according to an embodiment of the present disclosure. In this example embodiment, the removable liner 503 is loaded within the cyclone chamber 501 or extract collection container such that it hangs from the fluid stream inlet 507. In some embodiments, a cap (not shown) of the cyclone chamber 501 can be secured or screwed onto the cyclone chamber 501 using threading 505 on an interior surface of the cyclone chamber 501. Once the fractionation process has been completed and an extract is collected within the removable liner 503, the removable liner 503 can be taken out of the cyclone chamber 501 and replaced with a new liner. In a non-limiting example, the fluid stream inlet can include inlet tubing that circumferentially lines an internal surface of the cyclone chamber, or a portion of the cyclone chamber, and the removable liner can be connected or secured to this inlet tubing. In some embodiments, the removable liner 503 can be made of suitable materials, including but not limited to polyethylene, polypropylene, polytetrafluoroethylene, or polyethylene terephthalate.

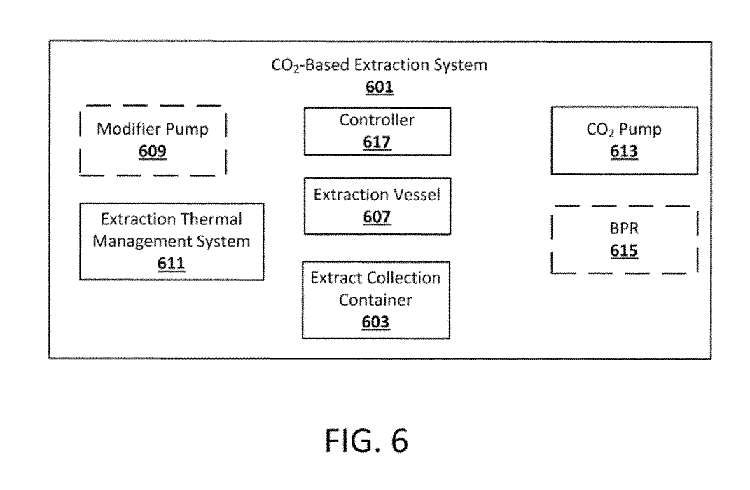

FIG. 6 is a diagram of an example CO₂-based extraction system 601 suitable for use with the removable liners described herein, according to an embodiment of the present disclosure. The CO₂-based extraction system 601 can include, for example, a modifier pump 609 (optional), a controller 617, a CO₂ pump 613, an extraction thermal management system 611, an extraction vessel 607, an extract collection container 603 or cyclone chamber that can include the removable liner as described above, and possibly a BPR 615 (optional). In some embodiments, the extraction vessel 607 is configured to generate an extract fluid flow that is directed to an inlet of the extract collection container 603, as described above. Such an extraction system can provide high yield and discrete CO₂-based extraction by preventing extract from remaining on the interior of the extract collection container 603 using the removable liners described herein.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

In describing certain examples, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps may be replaced with a single element, component or step. Likewise, a single element, component or step may be replaced with a plurality of elements, components or steps that serve the same purpose. Moreover, while example embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the disclosure.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methodologies, if such features, systems, articles, materials, kits, and/or methodologies are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method of extracting solid materials from liquid, gas or liquid-gas solutions, the method comprising:
securing a first removable liner within an extract collection container of a CO₂-based extraction system having a fluid stream inlet and a fluid stream outlet;
closing a cap of the extract collection container;
collecting a first solid material in the first removable liner by passing a first solution through the fluid stream inlet of the extract collection container;
depressurizing the extract collection container and removing the removable liner from the extract collection container; and
replacing and securing a second removable liner within the extract collection container.

2. The method of claim 1, further comprising: collecting a second solid material in the second removable liner by passing a second solution through the fluid stream inlet of the extract collection container.

3. The method of claim 2, wherein carryover of the first solid material into the second solid material is less than 10%.

4. The method of claim 2, wherein carryover of the first solid material into the second solid material is at least 10% less compared to carryover of the first solid material into the second solid material from a hydrocyclone separator without removable liners.

5. The method of claim 1, wherein passing the first solution through the fluid stream inlet generates an internal spiraling fluid flow to cause at least a partial material separation process.

6. The method of claim 1, wherein securing the first removable liner within the extract collection container includes securing the removable liner to a cylindrical section detachably connected to an open end of the extract collection container.

7. The method of claim 6, wherein securing the removable liner to the cylindrical section includes securing the removable liner to inlet tubing that circumferentially lines an internal surface of the cylindrical section.

8. The method of claim 1, wherein securing the first removable liner within the extract collection container includes positioning an inserted ring on a portion of an open end of the removable liner or using magnetic force to secure the open end of the removable liner to a portion of the extract collection container.

9. A CO₂-based extraction system comprising:
an extraction vessel of the CO2-based extraction system configured to generate an extract fluid flow including a mixture of an extract and CO₂,
an extract collection container having a fluid stream inlet and a fluid stream outlet, the fluid stream inlet configured to direct the extract fluid flow into the extract collection container and generate an internal spiraling fluid flow to cause at least a partial material separation process of the extract from the CO₂; and
a removable liner disposed within the extract collection container and covering at least a portion of an inner surface of the extract collection container, wherein the removable liner is configured to collect the extract and is sized to fit within the extract collection container.

10. The CO₂-based extraction system of claim 9, wherein the fluid stream inlet is a tangential inlet.

11. The CO₂-based extraction system of claim 9, wherein the removable liner symmetrically covers the between 10% and 100% of the inner surface of the extract collection container.

12. The CO₂-based extraction system of claim 9, further comprising a cylindrical section detachably connected to an open end of the extract collection container, and wherein the removable liner is connected to the cylindrical section.

13. The CO₂-based extraction system of claim 12, wherein the fluid stream inlet includes inlet tubing that circumferentially lines an internal surface of the cylindrical section, and the removable liner is connected to the inlet tubing.

14. The CO₂-based extraction system of claim 9, further comprising an inserted ring configured to cover a portion of an open end of the removable liner.

15. The CO₂-based extraction system of claim 9, wherein the extract collection container is a cone-shaped vessel.

16. A hydrocyclone separator, comprising:
a truncated cone-shaped vessel including a fluid stream inlet and a fluid stream outlet configured to generate an internal spiraling fluid flow in operation to cause at least a partial material separation process, and a truncated end;
a cone-shaped collector including an open end detachably connected to the truncated end of the truncated cone-shaped vessel; and
a removable liner disposed within the cone-shaped collector and covering at least a portion of an inner surface of the cone-shaped collector, wherein the liner is configured to collect solid material.

17. The hydrocyclone separator of claim 16, wherein the fluid stream inlet is a tangential inlet.

18. The hydrocyclone separator of claim 16, wherein the cone-shaped collector defines between 10% and 50% of a conical inner surface of the hydrocyclone separator.

19. The hydrocyclone separator of claim 16, wherein the truncated cone-shaped vessel includes a first flange at or near the truncated end, the cone-shaped collector includes a second flange at or near the open end, and a portion of the removable liner is secured between the first flange and the second flange.

20. The hydrocyclone separator of claim 16, wherein a conical angle of the truncated cone-shaped vessel and a conical angle of the cone-shaped collector are substantially the same.
